(19) United States
(12) Patent Application Publication
(10) Pub. No.: US 2021/0053135 A1
(43) Pub. Date: Feb. 25, 2021

(54) ORBITAL WELDING SYSTEM AND METHOD

(71) Applicant: Critical Systems, Inc., Boise, ID (US)

(72) Inventors: Theodore J Jones, Draper, UT (US); Ralph Vorraro, III, Fort Ann, NY (US); Richard Danner, II, Bryson City, NC (US)

(21) Appl. No.: 16/711,456

(22) Filed: Dec. 12, 2019

Related U.S. Application Data
(60) Provisional application No. 62/889,013, filed on Aug. 19, 2019.

(51) Int. Cl. B23K 9/095; B23K 9/028; B23K 9/16

(52) U.S. Cl. CPC B23K 9/0953; B23K 9/1006; B23K 9/16; B23K 9/0286

(57) ABSTRACT

Embodiments are directed to an orbital welding system, including customized orbital weld head fixtures, and computer-controlled programs for performing homogeneous orbital welds. In one scenario, an orbital welding system includes a controller, a shield gas supply system that supplies gases to an orbital welding tool, an electrical supply system that supplies an electrical current to the orbital welding tool, and the orbital welding tool, which includes a welding electrode that is configured to weld two or more items together using the supplied electrical current and the gases supplied by the gas supply system. The controller generates control signals that direct the orbital welding tool, the electrical supply system, and the gas supply system to homogeneously orbital weld the at least two items together, so that the at least two items are homogeneously welded together without using a filler material. Various other methods, systems, and apparatuses are also described.

### CROSS-REFERENCE TO RELATED APPLICATIONS

This application claims priority to and the benefit of U.S. Provisional Patent Application Ser. No. 62/889,013, entitled “Orbital Welding System and Method,” filed on Aug. 19, 2019, which application is incorporated by reference herein in its entirety.

### BACKGROUND

When pipes or other similar structures need to be welded, a variety of different techniques may be used to form a weld around the pipe. These techniques often include soldering or brazing in which a filler material (e.g., a brazing rod) is used to bind two pieces of pipe together. When welding tube or pipe, specifically those that use socket joints, the filler material penetrates the outer edge of the pipe, but does not penetrate the inner edge of the pipe that is being fitted. As such, the brazing process, once completed, is prone to leaks.

Moreover, using brazing materials in this manner is often complicated and typically requires specific skills. In some cases, brazing even requires the use of two workers, where one worker completes the brazed weld using a tool referred to as a “turbo torch” and the second worker (often called a “fire-watch”) remains on standby to put out potential fires using a fire extinguisher. This process is thus labor intensive and expensive. Still further, the use of a filler material during the orbital weld makes the weld take longer, thus lengthening the time spent by both workers on the job site.

### BRIEF SUMMARY

Embodiments described herein are directed to systems, methods, and apparatuses for performing homogeneous, full-penetration orbital welds. These welds may be performed faster and result in more reliable welds than previous brazing systems. In one embodiment, an orbital welding system described herein includes a controller, a shielding gas supply system that supplies shielding gas to an orbital welding tool or weld head, an electrical supply system that supplies an electrical current to the orbital welding tool, and the computer-controlled orbital welding tool itself. The orbital welding tool includes a welding electrode that is configured to weld various items together using the supplied electrical current and the shielding gases supplied by the gas supply system. The controller is configured to generate control signals that direct the orbital welding tool, the electrical supply system, and the shielding gas supply system to homogeneously orbital weld the items together, such that the items are welded together without using a filler material.

In some examples, the items being welded include socket joint members. In some cases, these socket joint members are made of copper. In some cases, the socket joint members include a larger socket joint member and a smaller socket joint member, where the smaller socket joint member is smaller than the larger socket joint member, and where the larger socket joint member at least partially overlaps the smaller socket joint member. In some embodiments, the homogenous orbital weld penetrates through both an inner layer of the larger socket joint member and an inner layer of the smaller socket joint member.

In some examples, the at least two items being welded include butt to butt joints. In such cases, the homogeneous orbital weld penetrates an outer layer of the butt to butt joints through to an inner layer of the butt to butt joints.

In some examples, the homogeneous orbital weld includes a root pass weld. In some examples, the homogeneous orbital weld is performed using one or more gases as a gas shield. In some examples, the controller controls the homogenous orbital weld according to a specific welding profile that specifies various orbital weld settings that are to be applied during the homogeneous, full-penetration orbital weld. In some cases, the welding profile that specifies the orbital weld settings that are to be applied during the homogeneous orbital weld is customized based on the specific metal that is to be welded or based on the type of fitting being welded.

In some examples, the orbital welding tool further includes customized orbital weld head fixtures. The customized orbital weld head fixtures may be affixed to the orbital welding tool. The customized orbital weld head fixtures may also be configured to clamp the at least two items together to hold the items in place while they are welded together.

A method for homogenously orbital welding at least two items together may also be provided, which includes arranging at least two items that are to be welded together into a specified position, orienting an orbital welding tool relative to the items, so that the orbital welding tool is positioned to apply a homogeneous orbital weld to the items, and generating control signals that direct the orbital welding tool, a shielding gas supply system, and an electrical supply system to homogeneously orbital weld the items together. As such, the items are homogeneously welded together without using a filler material.

In some examples, the items are clamped together using customized orbital weld head fixtures. In some examples, the items clamped together using the customized orbital weld head fixtures are homogeneously orbital welded together using a specified mixture of shielding gases. In some cases, the specified mixture of these gases may include about 70% to about 80% Helium, and about 20% to about 30% Argon. In other cases, the specified mixture of gases may include about 90% to about 99% Argon, and about 1% to about 10% Hydrogen. In still other cases, the specified mixture of gases may include about 85% to about 95% Argon, and about 5% to about 15% Hydrogen.

An apparatus for performing homogeneous, full-penetration orbital welds is also provided. The apparatus includes at least one physical processor, a shielding gas supply system that supplies gases to an orbital welding tool, an electrical supply system that supplies an electrical current to the orbital welding tool, an orbital welding tool including a welding electrode that is configured to weld two or more items together using the supplied electrical current and the gases supplied by the gas supply system. The apparatus also includes physical memory comprising computer-executable instructions that, when executed by the physical processor, cause the physical processor to generate control signals that direct the orbital welding tool, the electrical supply system, and the shielding gas supply system to homogeneously orbital weld the at least two items together, such that the items are homogeneously welded together without using a filler material.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates a system architecture in which embodiments described herein may operate including performing a homogeneous orbital weld.

FIGS. 2A, 2B, and 2C illustrate an embodiment of socket fitting a socket joint, where the socket joint is homogeneously orbital welded.

FIGS. 3A and 3B illustrate an embodiment of a butt to butt joint, where the butt to butt joint is homogeneously orbital welded.

FIG. 4 illustrates a perspective view of an orbital welding system configured to homogeneously orbital weld items together.

FIG. 5A illustrates a perspective view of a clamping apparatus in the closed position that may be used with an orbital welding system to homogeneously orbital weld items together.

FIG. 5B illustrates a perspective view of a clamping apparatus in the open position that may be used with an orbital welding system to homogeneously orbital weld items together.

FIG. 6 illustrates a perspective view of a schematic of a clamping apparatus including one or more of the components that may be used to assemble the clamping apparatus.

FIG. 7 illustrates a flowchart of a method for performing a homogeneous, full-penetration orbital weld of at least two items.

### DETAILED DESCRIPTION

The embodiments described herein include systems and methods of using an orbital welding device, as well as methods for manufacturing an orbital welding device. The orbital welding system may include a system controller that applies a weld at specified intervals or at specified amperages, and using specified shielding gases or gas ratios. The orbital welding system may also include an orbital welding tool configured to weld two or more items together. In some cases, the two or more items may be two ends of a pipe or socket joint that are orbital welded together using a homogeneous, full-penetration weld. The full-penetration weld may penetrate through to an inner layer of the innermost surface so as to avoid leakage. The orbital welding system may also include a gas supply system that supplies various shielding gases to the orbital welding tool. Methods of using the orbital welding system may include welding pipes, tubes, and socket or butt to butt weld fittings with full penetration to the inner layer of the inner joint.

In some embodiments, the orbital welding process involves a homogeneous, full-penetration weld on socket fittings or on tubing made of copper or other types of metal. The orbital welding process may be homogeneous in that it does not involve the use of filler material. As such, the pipes, tubes, or other items are welded together using the metal out of which the pipe or tube is made, without adding a filler material. The orbital welding process may be “full-penetration” in that the weld extends not just through the inner edge of the outer pipe, but through to the inner edge of the inner pipe. The homogeneous full-penetration orbital welding process described herein has proven to be more effective at stopping leaks than traditional brazing or soldering techniques. The homogeneous, full-penetration weld may be used in orbital welding or in other types of welding, and may be used on copper or substantially any other type of metal or metal alloy.

The embodiments described herein may not only include a method for performing the homogeneous, full-penetration orbital weld including controlling the welding gases and electrical current to make the welding possible, but may also include the orbital weld head with associated fixture tooling and clamping devices. Each of these embodiments will be described in greater detail below. The homogeneous orbital welding process may be supported by repeatable programming to provide proper amperage and speed control, leading to even, sound welds between joints. In the embodiments described herein, no filler metal is required to provide a sound, full-penetration weld.

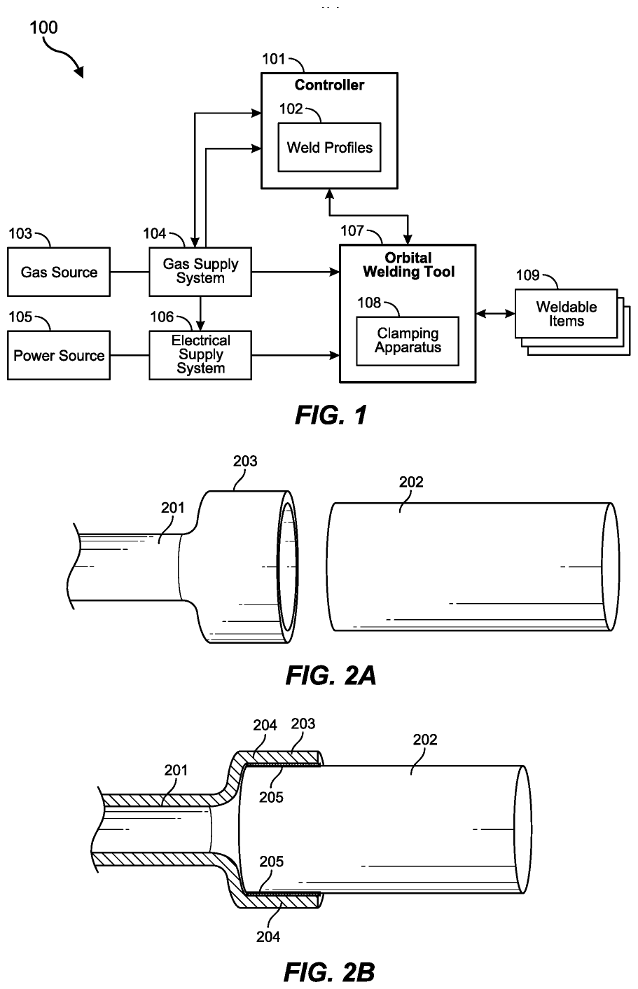

FIG. 1 illustrates an embodiment of a system diagram 100 including various components for performing a homogeneous, full-penetration orbital weld. For example, the system diagram 100 includes a controller 101. The controller may be substantially any type of processor, controller, programmable logic controller (PLC), or microcontroller, including an application-specific integrated circuit (ASIC), a field-programmable gate array (FPGA), an erasable programmable read-only memory (EPROM), or other type of processing device. In some cases, the controller 101 may operate alone, and in other cases, the controller may be part of an array of controllers. In such cases, these controllers may be linked via a wired or wireless computer network (e.g., WiFi, Bluetooth, cellular, etc.). The controller 101, whether acting alone or in conjunction with other controllers, may receive sensor inputs from and generate control signals for various supply systems including electrical and gas supply systems.

For example, the controller may receive pressure sensor inputs or flow sensor inputs from shielding gas supply system 104. The shielding gas supply system 104 may supply various inert or semi-inert gases from a gas source 103 to an orbital welding tool 107. The gas supply system 104 may be configured to supply very specific amounts of different gases (e.g., inert gases) during the welding process. The controller 101 may determine which gases to supply and how much of each gas to supply and when to supply each gas during the welding process. As will be explained further below, the gases may be used during the homogeneous orbital welding process as a shield to prevent corrosion and oxidation and to ensure that the homogeneous weld fully penetrates through to the inner portion of the inner pipe.

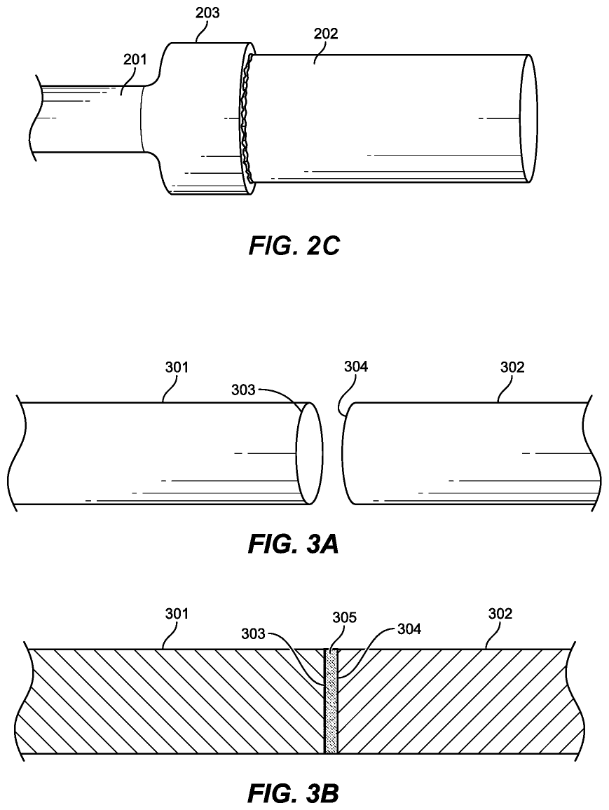

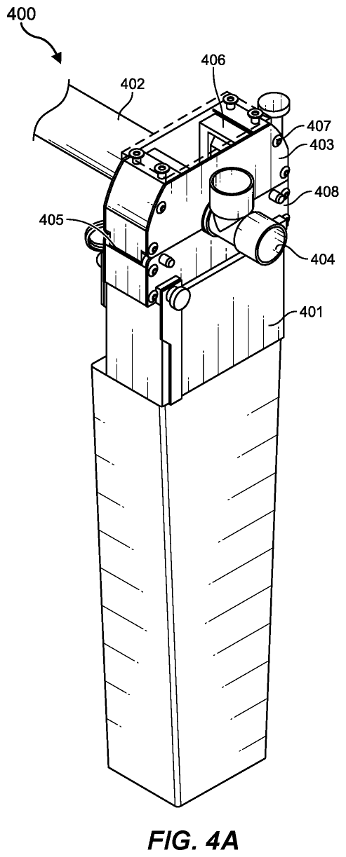

For instance, as shown in FIGS. 2A and 2B, a pipe 202 may be positioned into and welded to a socket fitting 203 on pipe 201. While the homogeneous, full-penetration orbital welding process described herein may be used with many different types and shapes of components or structural pieces, many of the embodiments herein will be described with reference to a socket fitting or to a butt to butt fitting (see FIGS. 3A and 3B). As shown in FIG. 2B, when the pipe 202 is inserted into the socket fitting 203, the pipe may be homogeneously orbital welded to the socket fitting. The socket fitting 203 has an outer layer and in inner layer, as does the pipe 202. When the pipe is homogeneously orbital welded to the socket fitting 203, the inner surface 204 of the socket fitting and the outer surface of the pipe are welded together. The weld, however, does not stop at this layer. Instead, the homogeneous, full-penetration orbital weld extends to the inner layer 205 of the pipe 202. Extending the weld to reach into the inner layer 205 of the inner pipe 202 ensures that the weld is fully sound, drastically reducing or eliminating fluid leaks through the welded portion of the pipes.

Still further, as noted above, this homogeneous, full-penetration orbital weld is performed without the use of a filler material. Traditional welding techniques involve soldering or brazing the two pipes together using some type of filler material. This filler material often forms imperfect seals leading to leaks and safety concerns. The homogeneous welds described herein uses the materials out of which the pipes themselves are made. Thus, if the pipes 201 and 202 in FIGS. 2A and 2B are made of copper, the homogeneous, full-penetration orbital weld will bind the two pipes at the socket fitting 203 using the copper atoms out of which the pipes are formed. The resulting weld bead 206 shown in FIG. 2C illustrates how the two pipes are joined together. This welding continues through along the inner edge of socket fitting 203 and the outer edge of pipe 202, securing the pipe 202 to the inner edges of the socket fitting 203 and, at least in some embodiments, to the base of the socket fitting 203. Pipes made of different types of metals may be homogenously welded in different ways, perhaps using different shielding gases, or different types of weld heads, or using a different amount of electrical current. The controller 101 of FIG. 1 may have access to different weld profiles 102 that specify various welding characteristics to apply to each weld. These characteristics may be different for different types of metals, different types of fittings, different thicknesses of pipes, or based on other traits of the items that are to be welded together 109. These weld profiles 102 may be selected automatically or may be selected manually by a user.

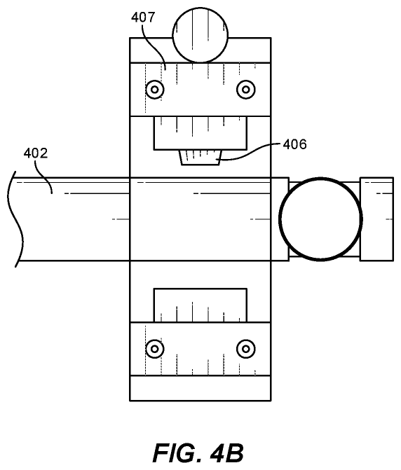

The controller 101 of FIG. 1 may further receive sensor inputs from and generate control signals for the electrical supply system 106. The electrical supply system 106 may receive power from a power source 105. The controller 101 may determine how much electrical current is sent from the electrical supply system 106 to the orbital welding tool 107. The electrical current sent from the electrical supply system 106 to the orbital welding tool is used by the welding tool's welding electrode to homogeneously orbital weld the weldable items 109 together. In some cases, the weldable items 109 may be held in place or may be aligned using a clamping apparatus (see FIGS. 4-6). The clamping apparatus 108 may include a clamp component that applies force to the weldable items. For example, in embodiments where the weldable items are pieces of pipe, the clamping apparatus 108 may be positioned over the socket fitting of the pipe (e.g., 203 of FIG. 2A) and may apply a clamping force from one or more directions, including applying a generally circular force from all angles in the circle. This process will be described in greater detail below with regard to FIGS. 4-6.

FIGS. 3A and 3B illustrate an alternative type of fitting. While FIGS. 2A and 2B illustrates a pipe socket fitting, FIGS. 3A and 3B illustrates a butt to butt fitting. The pipe 301 has an external-facing surface 303. This surface 303 faces the opposite external-facing surface 304 of pipe 302. The orbital welding tool 107 of FIG. 1 may be used to homogeneously orbital weld the pipes 301 and 302 together via a butt to butt joint 305. Upon completion, both external-facing surfaces 303 and 304 are welded together. The weld may be a homogeneous, full-penetration orbital weld. As such, the weld is performed without a filler material, and is performed by joining the two pipes (or other weldable items) using the material out of which the pipes are made. The two ends of pipes 301 and 302 may be aligned using the clamping apparatus 108. The orbital welding tool 107 may then apply an electrical current to the orbital welding tool's welding electrode and may use one or more gases from the gas source 103 to act as a shield for the weld. The homogeneous, full-penetration orbital weld may be performed on the butt to butt joint according to a weld profile 102 and thus may be specific to the type of materials that are being homogeneously welded and to the type of joint fitting being used. At least in some embodiments, the homogeneous, full-penetration orbital weld may be performed by the orbital welding tool 400 of FIG. 4.

FIG. 4 illustrates one embodiment of an orbital welding system 400. The orbital welding system 400 may include multiple components inside a structural housing 401 including a controller, a shielding gas supply system that supplies gases to an orbital welding tool 407, an electrical supply system that supplies an electrical current to the orbital welding tool, and a welding electrode 406 that is configured to weld two or more items together using the supplied electrical current and the shielding gases supplied by the gas supply system. In such a system, the controller may be configured to generate control signals that direct the orbital welding tool, the electrical supply system, and the shield gas supply system to homogeneously orbital weld the at least two items together. As such, the at least two items are homogeneously, orbital welded together without using a filler material.

As shown in FIG. 4, the two items being welded together are pipes 402 and 404. The pipe 404 has a socket fitting inside which pipe 402 has been positioned. The orbital welding tool 407 may rotate around the socket fitting of pipe 404 to homogeneously weld pipe 402 to pipe 404. In some embodiments, an automatic orbital welder may be used to weld tube or pipe workpieces having socket or butt to butt joint preparations. Accordingly, in such cases, the orbital welding system 400 of FIG. 4 may be an automatic orbital welder. The joint areas in the socket joint (e.g., as shown in FIGS. 2A & 2B) may have a specified land thickness at the root extremities. This land thickness may be minimized in order to increase the soundness of the weld and create a weld that is fully sealed. The orbital welding system 400 may allow various prepared workpiece joint sections to be arranged together next to an orbital fusion weld head. For example, workpiece joint sections 402 and 404 may be arranged together next to weld head 407. The weld head 407 may then make a full-penetration weld on the area of the adjacent workpieces. In some cases, the orbital weld may be a “root pass” weld using a shield gas including one or more inert gases supplied from the gas supply system.

In some embodiments, orbital welding of copper tube and fittings may involve a specialized automatic Gas Tungsten Arc Welding (GTAW) process. In this GTAW process, the arc of the welding device is continuously rotated mechanically around a static work piece. This specialized form of GTAW may be implemented using a variety of components including a computer-controlled power supply that provides arc current to the weld head. The specialized GTAW process includes feed and speed control to allow any orbital weld head to travel around the copper tube/pipe and fitting (work piece) in a steady and repeatable manner. The feed control determines the speed with which the rotating part or rotor gear of the weld tool (e.g., the weld head) travels around the tube or pipe. The rotor gear of the weld tool includes an affixed Tungsten Electrode, which creates the weld arc. In the case of an orbital weld, the feed and speed control regulate how fast the orbital welding tool is orbiting around the workpieces. The feed and speed control may be specified in a weld schedule program. The weld schedule program parameters may be developed for a specific type of joint or a specific type of metal or a specific type of weld head. The weld schedule program may be part of the weld profile (e.g., 102 of FIG. 1) that provides a consistent, full-penetration weld that extends to the internal surface of the tube/pipe or fitting. The weld schedule program is a series of computer-controlled signals sent to a motor which is connected to the rotor gear controlling the travel speed and a series of signals to the power source (e.g., 105 of FIG. 1) with specific amperage outputs that determine the amount of energy put into the tube or pipe to allow for a full penetration weld.

The weld schedule program may vary and may include: A) A program that utilizes a constant-speed rotation of a rotor gear. As used herein, the “rotor” refers to a component of the orbital weld head used to hold an electrode (e.g., a tungsten electrode). The rotor is a main gear (sometimes U-shaped) that rotates around the workpiece and pulses the amperage from high to low or at a steady state during the weld cycle, allowing the high pulse to fully penetrate the workpiece and the low pulse to propel travel of the weld puddle forward. B) A program that starts the weld at a high amperage, fully penetrating the workpiece, and allows the motor to speed up during operation of the weld cycle. This method allows the full-penetration weld to be controlled using the motor speed to control the weld depth and structural integrity of the weld zone. C) A program that utilizes a “Step-Pulse” method, whereby the motor is used to control small incremental steps. Each step may have a high amperage input, fully penetrating the workpiece, followed by a smaller incremental step of the motor moving the tungsten electrode a small amount relative to the workpiece and then implementing another high amperage pulse. This allow the weld zone to be controlled very closely as each high pulse is measured to fully penetrate the workpiece to the inner surface of the inner workpiece, but no further. This method may be described as a series of spot welds, each a small rotational increment from the other, allowing for a full weld bead (e.g., 206 of FIG. 2C) around the workpiece to be formed with high integrity.

The orbital welding system 400 may include a weld head 407 that has two jaws defining an opening between the jaws. The weld head 407 may be manufactured in two different pieces that are connected via a hinge 405. The hinge 405 may allow the upper portion of the weld head 403 to lower portion of the weld head 408. The weld head 407 may be placed in a welding position relative to the workpiece (e.g., pipe 402) by moving the workpiece through the opening between the jaws. The workpiece is then in a circular work space inside a rotor. The welding electrode 406 may be coupled to the rotor. As such, when the weld head 407 is actuated, the rotor rotates about the workpiece, and the welding electrode 406 orbits about the workpiece. An electric arc is produced between the electrode and the workpiece, and the heat of the arc welds the joint on the workpiece. In FIG. 4, for example, the electric arc welds the pipe 402 to the socket joint 404.

As noted above, the orbital weld head 407 may be a custom fixture. In at least some of the embodiments herein, the orbital weld head is designed so that it may be affixed to substantially any orbital welding device. The customized clamping system allows the orbital weld head to the affix to the tube or pipe work piece. This creates alignment of the orbital weld head electrode and provides superior physical shielding and gas shielding. Using this customized weld head 407, orbital welds may be performed much faster than traditional brazing welds because no filler needs to be applied during the process. Moreover, because the orbital weld fully penetrates the inner layer of the inner pipe or socket fitting, the weld is fully sealed, and leaks are substantially reduced or eliminated.

While FIG. 4 illustrates socket joint members, it will be understood that the orbital welding system 400 may be used to weld substantially any type of joints including butt to butt joints. Regardless of which type of joint is being welded, the embodiments herein may perform a full penetration weld, such that the homogeneous orbital weld penetrates the outer layer of the joints through to an inner layer of the joints. In some cases, these socket or butt to butt joint members may be made of copper. Specific amount of current and shield gas may be supplied to weld the copper joint members together. In some embodiments, the socket joint members may include a larger socket joint member and a smaller socket joint member. In such cases, the smaller socket joint member is smaller than the larger socket joint member, and the larger socket joint member at least partially overlaps the smaller socket joint member (e.g., see FIGS. 3A and 3B). When performed by the orbital welding system 400, the homogenous orbital weld penetrates through both an inner layer of the larger socket joint member and an inner layer of the smaller socket joint member.

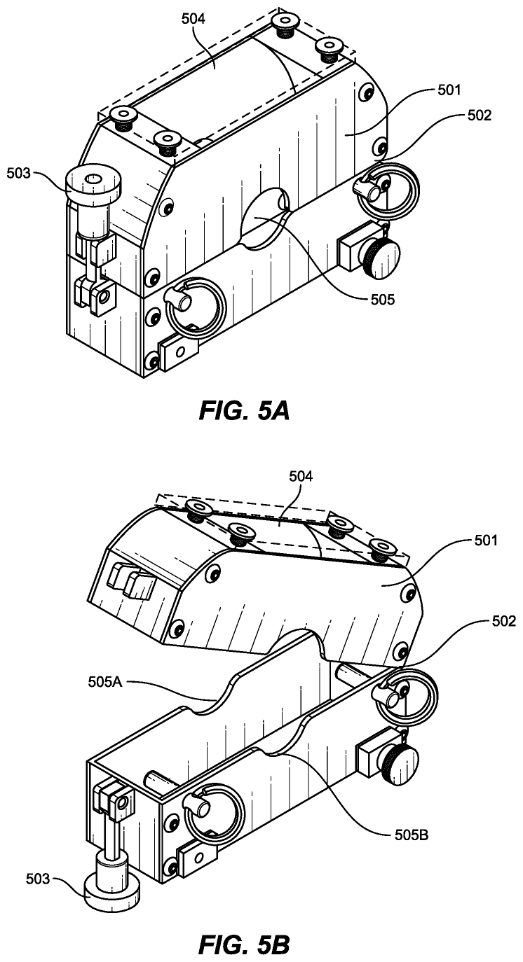

FIGS. 5A and 5B illustrate an example embodiment of a customized orbital weld head fixture 501 that may be applied to an orbital welding tool or orbital welding system. The customized orbital weld head fixture 501 may be affixed to the orbital welding tool in a permanent or semi-permanent manner using any of a variety of different fasteners. The customized orbital weld head fixture 501 may be configured to clamp the items together that are to be welded. For instance, the pips or other joint fittings may be fed through the opening 505. The customized orbital weld head fixture 501 may be opened by unclasping the pin 503 and allowing the upper portion to pivot on a hinge 502. The pipes or other joint fittings may be place in the jaws 505A and 505B. These jaws 505A/505B may hold the items in place and allow alignment of the tungsten electrode to the weld area while they are being welded together. A clear portion 504 may be affixed to the top of the customized orbital weld head fixture 501 so that the user may be able to see the pipes or other items that are being aligned.

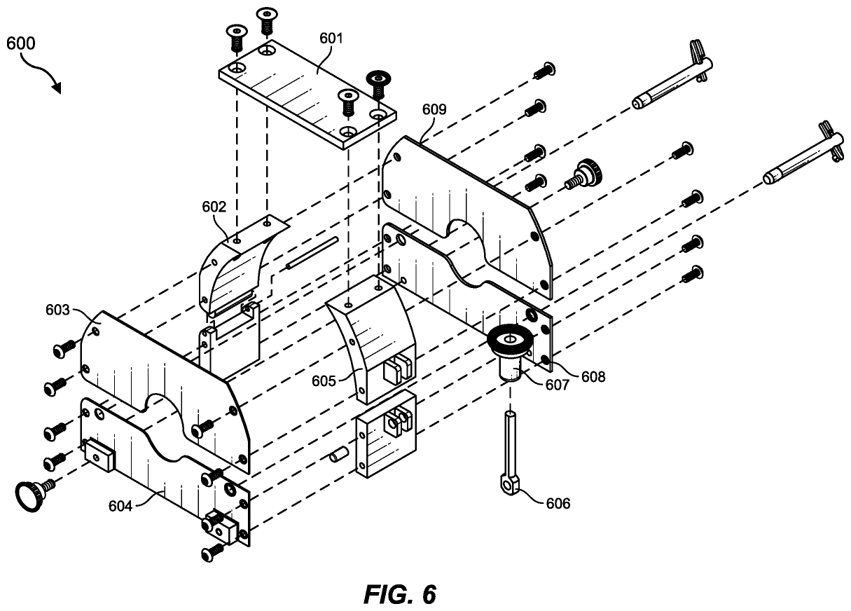

FIG. 6 illustrates a component diagram of an example embodiment of a customized orbital weld head fixture 600 that may be the same as or different than the weld head fixture 501 of FIG. 5. The customized orbital weld head fixture 600 may include side pieces 603 and 609 that form the top half of the customized orbital weld head fixture and pieces 604 and 608 that form the bottom half. Between these side pieces may be structural portions 602 and 605 that sit opposite each other and form a space for the weld head. This cavity may be visible through transparent covering piece 601. Various screws, pins (606 and 607), clasps and other fasteners may be used to hold the customized orbital weld head fixture 600 together. In some cases, pins or hinges may allow the customized orbital weld head fixture 600 to be opened to allow the opening (e.g., 505 of FIG. 5) to be positioned over the workpieces that are to be welded.

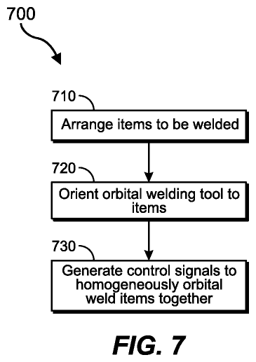

In view of the systems and architectures described above, methodologies that may be implemented in accordance with the disclosed subject matter will be better appreciated with reference to the flow chart of FIG. 7. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 7 illustrates a flowchart of a method 700 for performing a homogeneous, full-penetration orbital weld of at least two items. The method 700 will now be described with frequent reference to the components of FIGS. 1 and 4-6.

The method 700 for homogenously orbital welding at least two items together includes, at step 710, arranging at least two items that are to be welded together into a specified position. In FIG. 4, these items may be pipe 402 and socket fitting 404. At step 720, the method 700 includes orienting an orbital welding tool relative to the items, so that the orbital welding tool is positioned to apply a homogeneous orbital weld to the items. The customized orbital weld head fixture 501 of FIG. 5A or 600 of FIG. 6 may clamp on the pipe 402 and socket fitting 404 to orient the welding tool relative to the fittings, so that a homogeneous weld may be applied by the weld electrode. At step 730, then, the controller (e.g., 101 of FIG. 1) generates control signals that direct the orbital welding tool 107, the gas supply system 104, and the electrical supply system 106 to homogeneously orbital weld the at least two items 109 together. The items are then homogeneously welded together without using a filler material.

In some cases, the two items being welded together are made of the same material, while in other cases, the items may be made of different materials. In some examples, the controller controls the homogenous orbital weld according to a specific welding profile 102 that specifies various orbital weld settings that are to be applied during the homogeneous orbital weld. In some cases, for example, the welding profile that specifies the orbital weld settings that are to be applied during the homogeneous orbital weld is specific to the metal or metals that are to be welded. The welding profile may also specify which shielding gases are to be used to provide high-ionization in the weld, thereby reducing corrosion and oxidation.

In some cases, the weld profile may indicate the amount of electrical current that is to be supplied to the orbital welding tool. The weld profile 102 may also specify the amount of gas that is to be supplied to the orbital welding tool 107, along with an indication of which gases are to be supplied and the duration for which they are to be supplied. Each joint fitting may be made of different materials and these materials may have different thicknesses. These materials and thicknesses may respond differently to the arc provided by the weld head. Similarly, different gases may be more effective at providing shielding than others for different types of fittings, different types of materials, and different sizes of items being welded. Moreover, using customized weld head fixtures may also affect the weld profile, as these fixtures may provide some shielding and as such, smaller amounts of shield gases or different combinations of shield gases may be used with different weld head fixtures (e.g., customized orbital weld head fixture 501 of FIG. 5A).

In some embodiments, a user may manually input the weld profile to be used for a specified fitting. In other cases, the controller 101 may automatically determine which weld profile is to be used. For example, the controller 101 may receive sensor inputs from cameras, electrical current sensors, resistance sensors, capacitance sensors, or other sensors that provide an indication of which materials the items to be welded are made of Information from these sensors may be used to automatically select and implement a weld profile. Still further, other sensors may be used to monitor the flow of gases through the gas supply system or the flow of electricity through the electrical supply system. In some cases, the controller 101 may determine that an alternative weld profile would provide a better homogeneous orbital weld. Accordingly, in such cases, the controller may dynamically change the weld profile being applied.

Thus, if the sensor inputs to the controller 101 cause the controller to determine that a more effective weld profile is available (e.g., based on the type of fitting, the material(s) of the items being welded, the thickness of the items being welded, environmental conditions, etc.), the controller may dynamically switch to that weld profile and complete the weld using that profile (or even switching to a third or fourth profile if needed). In one specific example, a camera input may indicate that the weld puddle is not moving correctly across the weld and, as such, the controller may select a weld profile that would provide the appropriate amount of electrical current and shielding gas to properly move the weld puddle across the weld.

In some cases, the weldable items clamped together using the customized orbital weld head fixtures are homogeneously orbital welded together using a specified mixture of gases. The gases may be used as a shield and may include various mixtures. Some of these gas mixtures may include about 70% to about 80% Helium, and about 20% to about 30% Argon. In other cases, the specified mixture of gases may include about 90% to about 99% Argon, and about 1% to about 10% Hydrogen. In still other cases, the specified mixture of gases may include about 85% to about 95% Argon, and about 5% to about 15% Hydrogen. In more specific examples, the shield gases may be 75% He, and 25% Ar, or 75% He 25% Ar, or 95% Ar 5% H, or 90% Ar 10% H. In some cases, Nitrogen (N2) may be substituted for back purge shielding of the inner tube or pipe.

An apparatus may also be provided for performing homogeneous, full-penetration orbital welds is also provided. The apparatus includes at least one physical processor, a shield gas supply system that supplies gases to an orbital welding tool, an electrical supply system that supplies an electrical current to the orbital welding tool, an orbital welding tool including a welding electrode that is configured to weld two or more items together using the supplied electrical current and the gases supplied by the gas supply system. The apparatus also includes physical memory comprising computer-executable instructions that, when executed by the physical processor, cause the physical processor to generate control signals that direct the orbital welding tool, the electrical supply system, and the gas supply system to homogeneously orbital weld the at least two items together, such that the items are homogeneously welded together without using a filler material.

Embodiments of the physical processor or controller described herein may implement various types of computing systems. These computing systems may take a wide variety of forms. As used herein, the term “computing system” includes any device, system, or combination thereof that includes at least one processor, and a physical and tangible computer-readable memory capable of having thereon computer-executable instructions that are executable by the processor. A computing system may be distributed over a network environment and may include multiple constituent computing systems. For instance, computing systems may be standalone embedded devices, mobile phones, electronic appliances, laptop computers, tablet computers, wearable devices, desktop computers, mainframes, and the like.

A controller, microcontroller, or other type of computing device typically includes at least one hardware processing unit and a memory. The memory may be physical system memory, which may be volatile, non-volatile, or some combination of the two. The term “memory” may also be used herein to refer to non-volatile mass storage such as physical storage media or physical storage devices. If the computing system is distributed, the processing, memory and/or storage capability may be distributed as well.

As used herein, the term “executable module” or “executable component” can refer to software objects, routines, methods, or similar computer-executable instructions that may be executed on the computing system. The different components, modules, engines, and services described herein may be implemented as objects or processes that execute on the computing system (e.g., as separate threads). As described herein, a computing system may also contain communication channels that allow the computing system to communicate with other message processors over a wired or wireless network. Such communication channels may include hardware-based receivers, transmitters or transceivers, which are configured to receive data, transmit data or perform both.

Embodiments described herein also include physical computer-readable media for carrying or storing computer-executable instructions and/or data structures. Such computer-readable media can be any available physical media that can be accessed by a general-purpose or special-purpose computing system.

Computer storage media are physical hardware storage media that store computer-executable instructions and/or data structures. Physical hardware storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computing system to implement the disclosed functionality of the embodiments described herein. The data structures may include primitive types (e.g. character, double, floating-point), composite types (e.g. array, record, union, etc.), abstract data types (e.g. container, list, set, stack, tree, etc.), hashes, graphs or other any other types of data structures.

As used herein, computer-executable instructions comprise instructions and data which, when executed at one or more processors, cause a general-purpose computing system, special-purpose computing system, or special-purpose processing device to perform a certain function or group of functions. Computer-executable instructions may be, for example, binaries, intermediate format instructions such as assembly language, or even source code.

Those skilled in the art will appreciate that the principles described herein may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The embodiments herein may also be practiced in distributed system environments where local and remote computing systems, which are linked (either by hardwired data links, wireless data links, or by a combination of hardwired and wireless data links) through a network, both perform tasks. As such, in a distributed system environment, a computing system may include a plurality of constituent computing systems. In a distributed system environment, program modules may be located in both local and remote memory storage devices.

Those skilled in the art will also appreciate that the embodiments herein may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system

The concepts and features described herein may be embodied in other specific forms without departing from their spirit or descriptive characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

1. An orbital welding system, comprising:
a controller;
a shield gas supply system that supplies one or more inert or semi-inert gases to an orbital welding tool;
an electrical supply system that supplies an electrical current to the orbital welding tool;
a sensor; and
the orbital welding tool, which includes a welding electrode that is configured to weld two or more items together using the supplied electrical current and the one or more gases supplied by the gas supply system,
wherein the controller automatically identifies a weld profile based on one or more sensor inputs received from the sensor, the weld profile being specific to the type of weld being performed and specific to the type of materials being welded together, and
wherein the controller generates control signals according to the identified weld profile that direct the orbital welding tool, the electrical supply system, and the gas supply system to homogeneously orbital weld the at least two items together, such that the at least two items are homogeneously, orbital welded together without using a filler material.

2. The orbital welding system of claim 1, wherein the at least two items comprise socket joint members.

3. The orbital welding system of claim 2, wherein the socket joint members are made of copper.

4. The orbital welding system of claim 2, wherein the socket joint members comprise a larger socket joint member and a smaller socket joint member, the smaller socket joint member being smaller than the larger socket joint member, and wherein the larger socket joint member at least partially overlaps the smaller socket joint member.

5. The orbital welding system of claim 4, wherein the homogenous orbital weld penetrates through both an inner layer of the larger socket joint member and an inner layer of the smaller socket joint member.

6. The orbital welding system of claim 1, wherein the at least two items comprise butt to butt joints.

7. The orbital welding system of claim 6, wherein the homogeneous orbital weld penetrates an outer layer of the butt to butt joints through to an inner layer of the butt to butt joints.

8. The orbital welding system of claim 1, wherein the homogeneous orbital weld comprises a root pass weld.

9. The orbital welding system of claim 1, wherein the homogeneous orbital weld is performed using the one or more gases as a gas shield.

10. The orbital welding system of claim 1, wherein the controller controls the homogenous orbital weld according to a specific welding profile that specifies one or more orbital weld settings that are to be applied during the homogeneous orbital weld.

11. The orbital welding system of claim 10, wherein the welding profile that specifies one or more orbital weld settings that are to be applied during the homogeneous orbital weld is customized based on the specific metal that is to be welded.

12. The orbital welding system of claim 1, wherein the orbital welding tool further comprises one or more customized orbital weld head fixtures.

13. The orbital welding system of claim 12, wherein the one or more customized orbital weld head fixtures are affixed to the orbital welding tool, the customized orbital weld head fixtures being configured to clamp the at least two items together.

14. A method of homogenously orbital welding at least two items together, the method comprising:
arranging at least two items that are to be welded together into a specified position;
orienting an orbital welding tool relative to the at least two items, such that the orbital welding tool is positioned to apply a homogeneous orbital weld to the at least two items;
identifying a weld profile based on one or more sensor inputs received from the sensor, the weld profile being specific to the type of weld being performed and specific to the type of materials being welded together, and
generating one or more control signals according to the identified weld profile that direct the orbital welding tool, a shield gas supply system, and an electrical supply system to homogeneously orbital weld at least two items together, wherein the at least two items are homogeneously welded together without using a filler material.

15. The method of claim 14, further comprising clamping the at least two items together using one or more customized orbital weld head fixtures.

16. The method of claim 15, wherein the at least two items clamped together using the one or more customized orbital weld head fixtures are homogeneously orbital welded together using a specified mixture of gases.

17. The method of claim 16, wherein the specified mixture of gases includes 70% to 80% Helium, and 20% to 30% Argon.

18. The method of claim 16, wherein the specified mixture of gases includes 90% to 99% Argon, and 1% to 10% Hydrogen.

19. The method of claim 16, wherein the specified mixture of gases includes 85% to 95% Argon, and 5% to 15% Hydrogen.

20. An apparatus comprising:
at least one physical processor;
a shield gas supply system that supplies one or more gases to an orbital welding tool;
an electrical supply system that supplies an electrical current to the orbital welding tool;
a sensor;
the orbital welding tool including a welding electrode that is configured to weld two or more items together using the supplied electrical current and the one or more gases supplied by the gas supply system; and
physical memory comprising computer-executable instructions that, when executed by the physical processor, cause the physical processor to:
identify a weld profile based on one or more sensor inputs received from the sensor, the weld profile being specific to the type of weld being performed and specific to the type of materials being welded together; and
generate one or more control signals that direct the orbital welding tool, the electrical supply system, and the gas supply system to homogeneously orbital weld the at least two items together, wherein the at least two items are homogeneously welded together without using a filler material.
